(19) United States
(12) Patent Application Publication
(10) Pub. No.: US 2016/0195948 A1
(43) Pub. Date: Jul. 7, 2016

(54) TRANSPARENT CONDUCTIVE FILM AND PROCESS FOR PRODUCING TRANSPARENT CONDUCTIVE FILM

(71) Applicant: NITTO DENKO CORPORATION, Osaka (JP)

(72) Inventors: Hiroshi Tomohisa, Ibaraki-shi (JP); Ayami Nakato, Ibaraki-shi (JP); Kazumasa Okada, Ibaraki-shi (JP); Shouichi Matsuda, Ibaraki-shi (JP); Hiroyuki Takemoto, Ibaraki-shi (JP); Tadayuki Kameyama, Ibaraki-shi (JP)

(73) Assignee: NITTO DENKO CORPORATION, Ibaraki-shi, Osaka (JP)

(21) Appl. No.: 14/903,759

(22) PCT Filed: Jul. 8, 2014
(86) PCT No.: PCT/JP2014/068171

§ 371 Date: Jan. 8, 2016

(30) Foreign Application Priority Data
Jul. 9, 2013 (JP) 2013-143420

(51) Int. Cl. G06F 3/041

(52) U.S. Cl. CPC G06F 3/041; G06F 2203/04103

(57) ABSTRACT

There is provided a transparent conductive film having a hardly visible pattern of the conductive part (conductive pattern) can be provided. A transparent conductive film of the present invention includes: a transparent base material; and a transparent conductive layer arranged on at least one side of the transparent base material, wherein: the transparent conductive layer includes a conductive part and an insulation part; the conductive part includes a metal nanowire; and the insulation part includes an air bubble and/or a non-conductive light-scattering body.

### TECHNICAL FIELD

The present invention relates to a transparent conductive film and a method of producing a transparent conductive film.

### BACKGROUND ART

A transparent conductive film obtained by forming a metal oxide layer, such as an indium-tin composite oxide (ITO) layer, on a transparent resin film has heretofore been frequently used as an electrode for a touch sensor in an image display apparatus including the touch sensor. However, the transparent conductive film including the metal oxide layer involves a problem in that it is difficult to use the film in applications where bending resistance is required, such as a flexible display, because the conductivity of the film is liable to be lost owing to a crack caused by its bending.

Meanwhile, a transparent conductive film including a metal nanowire has been known as a transparent conductive film having high bending resistance. However, the transparent conductive film involves a problem in that incident light is scattered by the metal nanowire. When such transparent conductive film is used in an image display apparatus, the following problem occurs. The pattern of its conductive part including the metal nanowire (conductive pattern) is visually observed.

### CITATION LIST

### Patent Literature

[PTL 1] JP 2009-505358 A

### SUMMARY OF INVENTION

### Technical Problem

The present invention has been made to solve the above-mentioned problems, and an object of the present invention is to provide a transparent conductive film having a hardly visible conductive pattern despite including a metal nanowire.

### Solution to Problem

A transparent conductive film of the present invention includes: a transparent base material; and a transparent conductive layer arranged on at least one side of the transparent base material, wherein: the transparent conductive layer includes a conductive part and an insulation part; the conductive part includes a metal nanowire; and the insulation part includes an air bubble and/or a non-conductive light-scattering body.

In one embodiment of the present invention, an absolute value of a difference between a haze value of the conductive part and a haze value of the insulation part is 0.35% or less.

In one embodiment of the present invention, the air bubble has a diameter of from 1 nm to 10,000 nm.

In one embodiment of the present invention, the metal nanowire includes one or more kinds of metals selected from the group consisting of gold, platinum, silver, and copper.

According to another aspect of the present invention, there is provided a touch panel. The touch panel includes the transparent conductive film.

According to another aspect of the present invention, there is provided a method of producing a transparent conductive film. The method of producing a transparent conductive film includes the steps of: applying a metal nanowire dispersion liquid onto a transparent base material, followed by applying a resin solution onto the transparent base material having applied thereonto the metal nanowire dispersion liquid, to thereby form a transparent conductive layer; and removing the metal nanowire by a wet etching method using a mask having a predetermined pattern, to thereby form a conductive part having the predetermined pattern and an insulation part in the transparent conductive layer.

In one embodiment of the present invention, the resin solution contains a particle that is soluble in an etchant to be used in the wet etching method.

### Advantageous Effects of Invention

According to one embodiment of the present invention, the transparent conductive film having a hardly visible pattern of the conductive part (conductive pattern) can be provided. More specifically, the transparent conductive film according to the embodiment of the present invention includes the transparent conductive layer, and the transparent conductive layer includes the conductive part including the metal nanowire and the insulation part including the air bubble and/or the non-conductive light-scattering body. With this, a difference in manner of scattering of light between the conductive part and the insulation part is reduced, with the result that the transparent conductive film having a hardly visible conductive pattern can be obtained.

### BRIEF DESCRIPTION OF DRAWINGS

FIG. 1 is a schematic sectional view of a transparent conductive film according to one embodiment of the present invention.

FIG. 2 are optical microscope photographs of transparent conductive layers formed in Example and Comparative Example.

### DESCRIPTION OF EMBODIMENTS

### A. Entire Construction of Transparent Conductive Film

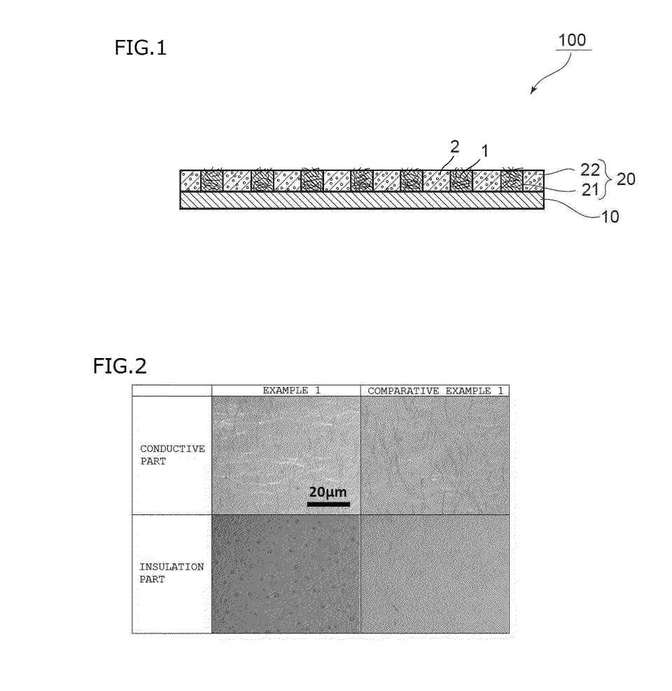

FIG. 1 is a schematic sectional view of a transparent conductive film according to one embodiment of the present invention. As illustrated in FIG. 1, a transparent conductive film 100 of the present invention includes a transparent base material 10 and a transparent conductive layer 20 arranged on at least one side of the transparent base material 10. The transparent conductive layer 20 includes a conductive part 21 and an insulation part 22, and the transparent conductive film 100 realizes its conductivity by virtue of the presence of the conductive part 21. The conductive part 21 is formed in a predetermined pattern in a plan view. It should be noted that the pattern of the conductive part 21 is sometimes referred to as “conductive pattern”. The conductive part 21 includes a metal nanowire 1. It is preferred that the conductive part 21 be formed of a resin matrix, and the metal nanowire 1 be present in the resin matrix. In one embodiment, the metal nanowire is present so that part thereof (for example, part having a length of from 0.1 μm to 1 μm) protrudes from the resin matrix. When part of the metal nanowire protrudes, a transparent conductive film to be suitably used as an electrode can be provided. The insulation part 22 includes air bubbles and/or a non-conductive light-scattering body (air bubbles 2 are illustrated in FIG. 1). It is preferred that the insulation part 22 be formed of a resin matrix, and the air bubbles or the non-conductive light-scattering body be present in the resin matrix. The resin matrix constituting the conductive part 21 and the resin matrix constituting the insulation part 22 may be formed of the same material or may be formed of different materials.

The total light transmittance of the transparent conductive film of the present invention is preferably 80% or more, more preferably 85% or more, particularly preferably 90% or more. In the present invention, a transparent conductive film having a high total light transmittance can be obtained by virtue of the presence of the conductive part including the metal nanowire. It should be noted that the “total light transmittance of the transparent conductive film” refers to a total light transmittance measured for the entire transparent conductive film including the conductive part and the insulation part.

The surface resistance value of the transparent conductive film of the present invention is preferably from 0.1Ω/□ to 1,000Ω/□, more preferably from 0.5Ω/□ to 500Ω/□, particularly preferably from 1Ω/□ to 250Ω/□. In the present invention, a transparent conductive film having a small surface resistance value can be obtained by virtue of the presence of the conductive part including the metal nanowire. In addition, with a small amount of the metal nanowire, the surface resistance value can be reduced as described above and hence excellent conductivity can be expressed. Accordingly, a transparent conductive film having a high light transmittance can be obtained.

### B. Transparent Base Material

An in-plane retardation Re of the transparent base material is from 1 nm to 100 nm, preferably from 1 nm to 50 nm, more preferably from 1 nm to 10 nm, still more preferably from 1 nm to 5 nm, particularly preferably from 1 nm to 3 nm. It should be noted that the term “in-plane retardation Re” as used herein refers to an in-plane retardation value of a transparent base material at 23° C. and a wavelength of 590 nm. The Re is determined from the equation “Re=(nx−ny) xd” where nx represents a refractive index in a direction in which an in-plane refractive index becomes maximum (i.e., a slow axis direction), ny represents a refractive index in a direction perpendicular to a slow axis in a plane (i.e., a fast axis direction), and d (nm) represents the thickness of an optical film.

The absolute value of a thickness direction retardation Rth of the transparent base material is 100 nm or less, preferably 75 nm or less, more preferably 50 nm or less, particularly preferably 10 nm or less, most preferably 5 nm or less. It should be noted that the term “thickness direction retardation Rth” as used herein refers to a thickness direction retardation value at 23° C. and a wavelength of 590 nm. The Rth is determined by the equation “Rth=(nx−nz)×d” where nx represents the refractive index in the direction in which the in-plane refractive index becomes maximum (i.e., the slow axis direction), nz represents a thickness direction refractive index, and d represents the thickness (nm) of the transparent base material.

The thickness of the transparent base material is preferably from 20 μm to 200 μm, more preferably from 30 μm to 150 μm. When the thickness falls within such range, a transparent base material having a small retardation can be obtained.

The total light transmittance of the transparent base material is preferably 80% or more, more preferably 85% or more, still more preferably 90% or more.

Any appropriate material may be used as a material constituting the transparent base material. Specifically, for example, a polymer base material, such as a film or a plastic base material, is preferably used. This is because the smoothness of the transparent base material and its wettability to a composition for forming a transparent conductive layer (a metal nanowire dispersion liquid or a resin solution described later) become excellent, and its productivity can be significantly improved by continuous production with a roll. A material capable of expressing the in-plane retardation Re and the thickness direction retardation Rth in the above-mentioned ranges is preferably used.

The material constituting the transparent base material is typically a polymer film containing a thermoplastic resin as a main component. Examples of the thermoplastic resin include: cycloolefin-based resins, such as polynorbornene; acrylic resins; and low-retardation polycarbonate resins. Of those, a cycloolefin-based resin or an acrylic resin is preferred. The use of such resin can provide a transparent base material having a small retardation. In addition, such resin is excellent in, for example, transparency, mechanical strength, thermal stability, and moisture barrier property. The thermoplastic resins may be used alone or in combination.

The polynorbornene refers to a (co)polymer obtained by using a norbornene-based monomer having a norbornene ring as part or all of its starting materials (monomers). Examples of the norbornene-based monomer include: norbornene, alkyl- and/or alkylidene-substituted products thereof, such as 5-methyl-2-norbornene, 5-dimethyl-2-norbornene, 5-ethyl-2-norbornene, 5-butyl-2-norbornene, and 5-ethylidene-2-norbornene, and polar group- (such as halogen-) substituted products thereof; dicyclopentadiene and 2,3-dihydrodicyclopentadiene; dimethanooctahydronaphthalene, alkyl- and/or alkylidene-substituted products thereof, and polar group- (such as halogen-) substituted products thereof; and a trimer and a tetramer of cyclopentadiene, such as 4,9:5,8-dimethano-3a,4,4a,5,8,8a,9,9a-octahydro-1H-benzoindene and 4,11:5,10:6,9-trimethano-3a,4,4a,5,5a,6,9,9a,10,10a,11,11a-dodecahydro-1H-cyclopentaanthracene.

Various products are commercially available as the polynorbornene. Specific examples thereof include products available under the trade names “ZEONEX” and “ZEONOR” from Zeon Corporation, a product available under the trade name “Arton” from JSR Corporation, a product available under the trade name “TOPAS” from TICONA, and a product available under the trade name “APEL” from Mitsui Chemicals, Inc.

The acrylic resin refers to a resin having a repeating unit derived from a (meth)acrylate ((meth)acrylate unit) and/or a repeating unit derived from (meth)acrylic acid ((meth)acrylic acid unit). The acrylic resin may have a constituent unit derived from a derivative of a (meth)acrylate or (meth)acrylic acid.

In the acrylic resin, the total content of the (meth)acrylate unit, the (meth)acrylic acid unit, and the constituent unit derived from a derivative of a (meth)acrylate or (meth)acrylic acid is preferably 50 wt % or more, more preferably from 60 wt % to 100 wt %, particularly preferably from 70 wt % to 90 wt % with respect to all constituent units constituting the acrylic resin. When the total content falls within such range, a transparent base material having a low retardation can be obtained.

The acrylic resin may have a ring structure on its main chain. The presence of the ring structure can increase the glass transition temperature of the acrylic resin while suppressing an increase in its retardation. Examples of the ring structure include a lactone ring structure, a glutaric anhydride structure, a glutarimide structure, an N-substituted maleimide structure, and a maleic anhydride structure.

The lactone ring structure can adopt any appropriate structure. The lactone ring structure is preferably a four- to eight-membered ring, more preferably a five-membered ring or a six-membered ring, still more preferably a six-membered ring. A six-membered lactone ring structure is, for example, a lactone ring structure represented by the following general formula (1).

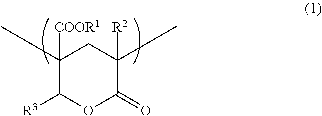

In the general formula (1), R¹, R², and R³ each independently represent a hydrogen atom, a linear or branched alkyl group having 1 to 20 carbon atoms, an unsaturated aliphatic hydrocarbon group having 1 to 20 carbon atoms, or an aromatic hydrocarbon group having 1 to 20 carbon atoms. The alkyl group, the unsaturated aliphatic hydrocarbon group, and the aromatic hydrocarbon group may each have a substituent such as a hydroxyl group, a carboxyl group, an ether group, or an ester group.

The glutaric anhydride structure is, for example, a glutaric anhydride structure represented by the following general formula (2). The glutaric anhydride structure can be obtained by, for example, subjecting a copolymer of a (meth)acrylate and (meth)acrylic acid to intramolecular dealcoholization cyclization condensation.

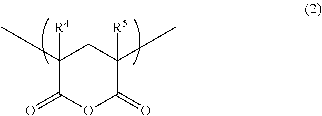

In the general formula (2), R⁴ and R⁵ each independently represent a hydrogen atom or a methyl group.

The glutarimide structure is, for example, a glutarimide structure represented by the following general formula (3). The glutarimide structure can be obtained by, for example, imidizing a (meth)acrylate polymer with an imidizing agent, such as methylamine.

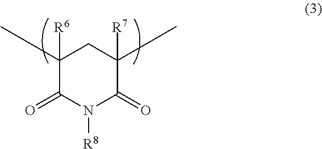

In the general formula (3), R⁶ and R⁷ each independently represent a hydrogen atom, or a linear or branched alkyl group having 1 to 8 carbon atoms, preferably a hydrogen atom or a methyl group. R⁸ represents a hydrogen atom, a linear alkyl group having 1 to 18 carbon atoms, a cycloalkyl group having 3 to 12 carbon atoms, or an aryl group having 6 to 10 carbon atoms, preferably a linear alkyl group having 1 to 6 carbon atoms, a cyclopentyl group, a cyclohexyl group, or a phenyl group.

In one embodiment, the acrylic resin has a glutarimide structure represented by the following general formula (4) and a methyl methacrylate unit.

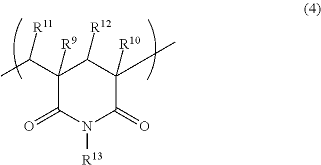

In the general formula (4), R⁹ to R¹² each independently represent a hydrogen atom, or a linear or branched alkyl group having 1 to 8 carbon atoms. R¹³ represents a linear or branched alkyl group having 1 to 18 carbon atoms, a cycloalkyl group having 3 to 12 carbon atoms, or an aryl group having 6 to 10 carbon atoms.

The N-substituted maleimide structure is, for example, an N-substituted maleimide structure represented by the following general formula (5). An acrylic resin having the N-substituted maleimide structure on its main chain can be obtained by, for example, copolymerizing an N-substituted maleimide and a (meth)acrylate.

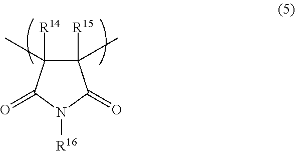

In the general formula (5), R¹⁴ and R¹⁵ each independently represent a hydrogen atom or a methyl group, and R¹⁶ represents a hydrogen atom, a linear alkyl group having 1 to 6 carbon atoms, a cyclopentyl group, a cyclohexyl group, or a phenyl group.

The maleic anhydride structure is, for example, amaleic anhydride structure represented by the following general formula (6). An acrylic resin having the maleic anhydride structure on its main chain can be obtained by, for example, copolymerizing maleic anhydride and a (meth)acrylate.

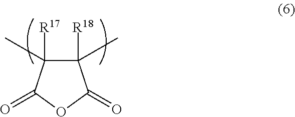

In the general formula (6), R¹⁷ and R¹⁸ each independently represent a hydrogen atom or a methyl group.

The acrylic resin may have any other constituent unit. Examples of the other constituent unit include constituent units derived from monomers such as styrene, vinyltoluene, α-methylstyrene, acrylonitrile, methyl vinyl ketone, ethylene, propylene, vinyl acetate, methallyl alcohol, allyl alcohol, 2-hydroxymethyl-1-butene, α-hydroxymethylstyrene, α-hydroxyethylstyrene, a 2-(hydroxyalkyl)acrylate, such as methyl 2-(hydroxyethyl)acrylate, and a 2-(hydroxyalkyl) acrylic acid, such as 2-(hydroxyethyl)acrylic acid.

In addition to the acrylic resins exemplified above, specific examples of the acrylic resin also include acrylic resins disclosed in JP 2004-168882 A, JP 2007-261265 A, JP 2007-262399 A, JP 2007-297615 A, JP 2009-039935 A, JP 2009-052021 A, and JP 2010-284840 A.

The glass transition temperature of the material constituting the transparent base material is preferably from 100° C. to 200° C., more preferably from 110° C. to 150° C., particularly preferably from 110° C. to 140° C. When the glass transition temperature falls within such range, a transparent conductive film excellent in heat resistance can be obtained.

The transparent base material may further contain any appropriate additive as required. Specific examples of the additive include a plasticizer, a heat stabilizer, a light stabilizer, a lubricant, an antioxidant, a UV absorber, a flame retardant, a coloring agent, an antistatic agent, a compatibilizer, a cross-linking agent, and a thickener. The kind and amount of the additive to be used may be appropriately set depending on purposes.

Any appropriate molding method is employed as a method of obtaining the transparent base material, and a proper method can be appropriately selected from, for example, a compression molding method, a transfer molding method, an injection molding method, an extrusion molding method, a blow molding method, a powder molding method, a FRP molding method, and a solvent casting method. Of those production methods, an extrusion molding method or a solvent casting method is preferably employed. This is because the smoothness of the transparent base material to be obtained is improved and hence good optical uniformity can be obtained. Molding conditions can be appropriately set depending on, for example, the composition and kind of the resin to be used.

The transparent base material may be subjected to various surface treatments as required. Any appropriate method is adopted for such surface treatment depending on purposes. Examples thereof include a low-pressure plasma treatment, an ultraviolet irradiation treatment, a corona treatment, a flame treatment, and acid and alkali treatments. In one embodiment, the surface of the transparent base material is hydrophilized by subjecting the transparent base material to a surface treatment. When the transparent base material is hydrophilized, processability upon application of a composition for forming a transparent conductive layer (a metal nanowire dispersion liquid or a resin solution described later) prepared with an aqueous solvent becomes excellent. In addition, a transparent conductive film excellent in adhesiveness between the transparent base material and the transparent conductive layer can be obtained.

### C. Transparent Conductive Layer

The transparent conductive layer includes a conductive part and an insulation part. The conductive part is formed in any appropriate pattern in a plan view. The insulation part is a part in which the conductive part is not formed in a plan view of the transparent conductive layer.

The thickness of the transparent conductive layer is preferably from 0.01 μm to 10 μm, more preferably from 0.05 μm to 3 μm, particularly preferably from 0.1 μm to 1 μm. When the thickness falls within such range, a transparent conductive film excellent in conductivity and light transmittance can be obtained.

The total light transmittance of the transparent conductive layer is preferably 85% or more, more preferably 90% or more, still more preferably 95% or more. It should be noted that the “total light transmittance of the transparent conductive layer” refers to a total light transmittance measured for the entire transparent conductive layer including the conductive part and the insulation part.

The conductive part includes a metal nanowire. The metal nanowire refers to a conductive substance that is made of a metal material, has a needle- or thread-like shape, and has a diameter of the order of nanometers. The metal nanowire may be linear or may be curved. When an electrical conduction path is formed of the conductive part including the metal nanowire, a transparent conductive film excellent in bending resistance can be obtained. In addition, when the metal nanowire is used, the metal nanowire is formed into a network shape. Accordingly, even when a small amount of the metal nanowire is used, a good electrical conduction path can be formed and hence a transparent conductive film having a small electrical resistance can be obtained. Further, the metal nanowire is formed into a network shape, and hence an opening portion is formed in a gap of the network. As a result, a transparent conductive film having a high light transmittance can be obtained.

A ratio (aspect ratio: L/d) between a thickness d and a length L of the metal nanowire is preferably from 10 to 100,000, more preferably from 50 to 100,000, particularly preferably from 100 to 10,000. When a metal nanowire having such large aspect ratio as described above is used, the metal nanowire satisfactorily intersects with itself and hence high conductivity can be expressed with a small amount of the metal nanowire. As a result, a transparent conductive film having a high light transmittance can be obtained. It should be noted that the term “thickness of the metal nanowire” as used herein has the following meanings: when a section of the metal nanowire has a circular shape, the term means the diameter of the circle; when the section has an elliptical shape, the term means the short diameter of the ellipse; and when the section has a polygonal shape, the term means the longest diagonal of the polygon. The thickness and length of the metal nanowire can be observed with a scanning electron microscope or a transmission electron microscope.

The thickness of the metal nanowire is preferably less than 500 nm, more preferably less than 200 nm, particularly preferably from 10 nm to 100 nm, most preferably from 10 nm to 50 nm. When the thickness falls within such range, a transparent conductive layer having a high light transmittance can be formed.

The length of the metal nanowire is preferably from 2.5 μm to 1,000 μm, more preferably from 10 μm to 500 μm, particularly preferably from 20 μm to 100 μm. When the length falls within such range, a transparent conductive film having high conductivity can be obtained.

Any appropriate metal can be used as a metal constituting the metal nanowire as long as the metal has high conductivity. The metal nanowire preferably contains one or more kinds of metals selected from the group consisting of gold, platinum, silver, and copper. Of those, silver, copper, or gold is preferred from the viewpoint of conductivity, and silver is more preferred. In addition, a material obtained by subjecting the metal to metal plating (e.g., gold plating) may be used.

The content of the metal nanowire in the conductive part is preferably from 30 wt % to 96 wt %, more preferably from 43 wt % to 88 wt % with respect to the total weight of the conductive part. When the content falls within such range, a transparent conductive film excellent in conductivity and light transmittance can be obtained.

When the metal nanowire is a silver nanowire, the density of the conductive part is preferably from 1.3 g/cm³ to 7.4 g/cm³, more preferably from 1.6 g/cm³ to 4.8 g/cm³. When the density falls within such range, a transparent conductive film excellent in conductivity and light transmittance can be obtained.

Any appropriate method can be adopted as a method of producing the metal nanowire. Examples thereof include: a method involving reducing silver nitrate in a solution; and a method involving causing an applied voltage or current to act on a precursor surface from the tip portion of a probe, drawing a metal nanowire at the tip portion of the probe, and continuously forming the metal nanowire. In the method involving reducing silver nitrate in the solution, a silver nanowire can be synthesized by performing the liquid-phase reduction of a silver salt, such as silver nitrate, in the presence of a polyol, such as ethylene glycol, and polyvinyl pyrrolidone. The mass production of a silver nanowire having a uniform size can be performed in conformity with a method described in, for example, Xia, Y. et al., Chem. Mater. (2002), 14, 4736-4745 or Xia, Y. et al., Nano letters (2003), 3 (7), 955-960.

It is preferred that the conductive part be formed of a resin matrix, and the metal nanowire be present in the resin matrix.

Any appropriate resin can be used as a material for forming the resin matrix constituting the conductive part. Examples of the resin include: an acrylic resin; a polyester-based resin, such as polyethylene terephthalate; aromatic resins, such as polystyrene, polyvinyltoluene, polyvinylxylene, polyimide, polyamide, and polyamide imide; a polyurethane-based resin; an epoxy-based resin; a polyolefin-based resin; an acrylonitrile-butadiene-styrene copolymer (ABS); cellulose; a silicon-based resin; polyvinyl chloride; polyacetate; polynorbornene; a synthetic rubber; and a fluorine-based resin. Of those, a curable resin constituted of a polyfunctional acrylate (preferably a UV-curable resin), such as pentaerythritol triacrylate (PETA), neopentyl glycol diacrylate (NPGDA), dipentaerythritol hexaacrylate (DPHA), dipentaerythritol pentaacrylate (DPPA), or trimethylolpropane triacrylate (TMPTA), is preferably used.

A conductive resin may be used as the material for forming the resin matrix constituting the conductive part. Examples of the conductive resin include poly(3,4-ethylenedioxythiophene) (PEDOT), polyaniline, polythiophene, and polydiacetylene.

The insulation part includes air bubbles and/or a non-conductive light-scattering body. It is preferred that the insulation part be formed of a resin matrix, and the air bubbles or the non-conductive light-scattering body be present in the resin matrix. When the insulation part includes the air bubbles or the non-conductive light-scattering body, incident light is scattered even in the insulation part. In the present invention, a transparent conductive film having a hardly visible conductive pattern can be obtained by reducing a difference between the light-scattering property of the insulation part and the light-scattering property of the conductive part having a light-scattering property by virtue of the presence of the metal nanowire (specifically, a difference in haze value). Further, both the air bubbles and the light-scattering body for imparting a light-scattering property are non-conductive, and hence the conductivity in the insulation part is reliably suppressed. Thus, a transparent conductive film having high reliability can be obtained.

As a material for forming the resin matrix constituting the insulation part, a material similar to that for forming the resin matrix constituting the conductive part may be used. The resin matrix constituting the conductive part and the resin matrix constituting the insulation part may be formed of the same material or may be formed of different materials.

The diameter of each of the air bubbles is preferably from 1 nm to 10,000 nm, more preferably from 100 nm to 5,000 nm. The haze value of the insulation part can be adjusted with the size of the air bubble.

In the case where the insulation part includes the air bubbles, the apparent specific gravity of the insulation part is preferably from 80.0% to 99.9%, more preferably from 85.0% to 99.5%, particularly preferably from 90.0% to 99.0% with respect to the absolute specific gravity of the insulation part. The haze value of the insulation part can be adjusted with the apparent specific gravity of the insulation part, that is, the amount of the air bubbles. The absolute specific gravity of the insulation part refers to the specific gravity of the insulation part in the case where it is assumed that the air bubbles do not exist and refers to the specific gravity of a resin for forming a resin matrix in the case where the insulation part is formed of the resin matrix.

Examples of the non-conductive light-scattering body include a metal oxide, a metal nitride, and a metal oxynitride which do not have conductivity. The light-scattering body may have any appropriate shape as long as the light-scattering body can scatter incident light. As the shape of the light-scattering body, there may be given a spherical shape, an oval spherical shape, and a wire shape. In the case where the light-scattering body has a spherical shape, the diameter thereof is preferably from 1 nm to 10,000 nm, more preferably from 100 nm to 5,000 nm. In the case where the light-scattering body has an oval spherical shape, the short diameter thereof is preferably from 1 nm to 10,000 nm, more preferably from 100 nm to 5,000 nm, and the long diameter thereof is preferably from 100 nm to 100,000 nm, more preferably from 1,000 nm to 50,000 nm. In the case where the light-scattering body has a wire shape, the length thereof is preferably from 100 nm to 100,000 nm, more preferably from 1,000 nm to 50,000 nm. The haze value of the insulation part can be adjusted with the material constituting the light-scattering body or the size thereof.

The content of the non-conductive light-scattering body is preferably from 0.1 vol % to 20.0 vol %, more preferably from 0.5 vol % to 15.0 vol %, particularly preferably from 1.0 vol % to 10.0 vol % with respect to the entire volume of the insulation part.

The absolute value of a difference between the haze value of the conductive part and the haze value of the insulation part is preferably 0.35% or less, more preferably 0.3% or less. When the absolute value falls within such range, a transparent conductive film having a hardly visible conductive pattern can be obtained.

The haze value of the conductive part is preferably 5% or less, more preferably 2% or less, particularly preferably 1.5% or less. The haze value of the insulation part is preferably 5% or less, more preferably 2% or less, still more preferably 1.5% or less, particularly preferably 1% or less.

### D. Other Layer

The transparent conductive film may include any appropriate other layer as required. Examples of the other layer include a hard coat layer, an antistatic layer, an antiglare layer, an antireflection layer, and a color filter layer.

The hard coat layer has a function of imparting chemical resistance, scratch resistance, and surface smoothness to the transparent base material.

Any appropriate material can be adopted as a material constituting the hard coat layer. Examples of the material constituting the hard coat layer include an epoxy-based resin, an acrylic resin, and a silicone-based resin, and a mixture thereof. Of those, an epoxy-based resin excellent in heat resistance is preferred. The hard coat layer can be obtained by curing any such resin with heat or an active energy ray.

### E. Method of Producing Transparent Conductive Film

### First Embodiment

In one embodiment, for example, a method of producing a transparent conductive film of the present invention includes the steps of: applying a metal nanowire dispersion liquid onto a transparent base material (application, drying), followed by applying a resin solution onto the transparent base material having applied thereonto the metal nanowire dispersion liquid, to thereby form a transparent conductive layer; and removing the metal nanowire by a wet etching method using a mask having a predetermined pattern, to thereby form a conductive part having the predetermined pattern and an insulation part in the transparent conductive layer.

As the transparent base material, the transparent base material described in the section B may be used.

The metal nanowire dispersion liquid can be obtained by dispersing the metal nanowire described in the section C in any appropriate solvent. Examples of the solvent include water, an alcohol-based solvent, a ketone-based solvent, an ether-based solvent, a hydrocarbon-based solvent, and an aromatic solvent. Water is preferably used from the viewpoint of a reduction in environmental load.

The dispersion concentration of the metal nanowire in the metal nanowire dispersion liquid is preferably from 0.1 wt % to 1 wt %. When the dispersion concentration falls within such range, a transparent conductive layer excellent in conductivity and light transmittance can be formed.

The metal nanowire dispersion liquid may further contain any appropriate additive depending on purposes. Examples of the additive include an anticorrosive material for preventing the corrosion of the metal nanowire and a surfactant for preventing the agglomeration of the metal nanowire. The kinds, number, and amount of additives to be used can be appropriately set depending on purposes. In addition, the metal nanowire dispersion liquid may contain any appropriate binder resin as required as long as the effects of the present invention are obtained.

Any appropriate method can be adopted as an application method for the metal nanowire dispersion liquid. Examples of the application method include spray coating, bar coating, roll coating, die coating, inkjet coating, screen coating, dip coating, slot die coating, a relief printing method, an intaglio printing method, and a gravure printing method. Any appropriate drying method (such as natural drying, blast drying, or heat drying) can be adopted as a method of drying the applied layer. In the case of, for example, the heat drying, a drying temperature is typically from 100° C. to 200° C. and a drying time is typically from 1 minute to 10 minutes.

As described above, after the metal nanowire dispersion liquid is applied onto the transparent base material, the resin solution is applied onto the transparent base material (application, drying), to thereby form the transparent conductive layer. With this operation, the transparent conductive layer in which the metal nanowire is present in a resin matrix is formed. It should be noted that, in the first embodiment, in a stage in which the resin solution is applied, the insulation part is not formed, and the entire transparent conductive layer has conductivity.

The resin solution contains a resin constituting the resin matrix described in the section C or a precursor of the resin (a monomer constituting the resin).

The resin solution may contain a solvent. Examples of the solvent to be incorporated into the resin solution include an alcohol-based solvent, a ketone-based solvent, tetrahydrofuran, a hydrocarbon-based solvent, and an aromatic solvent. The solvent is preferably volatile. The boiling point of the solvent is preferably 200° C. or less, more preferably 150° C. or less, still more preferably 100° C. or less.

The resin solution preferably contains particles which are soluble in an etchant to be used in the wet etching method in the subsequent step. As a result of etching treatment in the subsequent step, the metal nanowire is removed from a region that is not masked, and the region becomes the insulation part. When the resin solution contains the soluble particles, the particles are removed with the etchant in the region, and air bubbles can be formed in the resin matrix constituting the insulation part. The insulation part thus formed has a light-scattering property and may contribute to a decrease invisibility of a conductive pattern. As the soluble particles, for example, there may be given hollow nanosilica and hollow titania. The size and content of the particles may be set depending on the size and amount of desired air bubbles.

The resin solution may further contain any appropriate additive depending on purposes. Examples of the additive include a cross-linking agent, a polymerization initiator, a stabilizer, a surfactant, and a corrosion inhibitor.

As an application method for the resin solution, a method similar to that for the dispersion liquid may be employed. As a drying method, any appropriate drying method (for example, natural drying, blast drying, or heat drying) may be employed. In the case of, for example, the heat drying, a drying temperature is typically from 100° C. to 200° C., and a drying time is typically from 1 minute to 10 minutes. Further, after drying, curing treatment may be performed. The curing treatment may be performed under any appropriate condition depending on the resin constituting the resin matrix.

After the transparent conductive layer is formed as described above, the conductive part and the insulation part are formed by the wet etching method. In this embodiment, the metal nanowire is removed in the region that is not masked, by the wet etching method. Further, in the region that is not masked, the soluble particles are removed, and as a result, air bubbles are generated in the insulation part. It should be noted that the resin matrix remains also in the region that is not masked. As the wet etching method, any appropriate method may be employed. As a specific operation of the wet etching method, for example, there may be given an operation disclosed in US 2011/0253668 A. This publication is incorporated herein by reference.

A mask to be used in the wet etching method may be formed into any appropriate shape depending on a desired conductive pattern. After the etching treatment, a region in which the mask is formed becomes the conductive part, and a region in which the mask is not formed becomes the insulation part. The mask is formed of, for example, a photosensitive resin or the like. As a method of forming the mask, for example, there may be given a screen printing method.

After the mask is formed, the transparent conductive layer (substantially, a laminate of the transparent conductive layer and the transparent base material) is immersed in the etchant, to thereby perform the etching treatment. As the etchant, for example, an etchant capable of dissolving the metal nanowire or an etchant capable of converting a metal constituting the metal nanowire into a metal ion may be used. Further, it is preferred that the etchant be capable of dissolving the above-mentioned particles. Specific examples of the etchant include nitric acid, phosphoric acid, acetic acid, hydrochloric acid, and a mixed solution thereof. In the case of using the etchant capable of converting a metal constituting the metal nanowire into a metal ion, it is preferred that the metal ion be removed through use of any appropriate cleaning solution (for example, water) after the etching treatment. The mask is removed by an ordinary method after the etching treatment.

As described above, a transparent conductive film having the transparent conductive layer including the conductive part including the metal nanowire and the insulation part can be obtained. In the insulation part, the metal nanowire has been removed, and air bubbles have been formed. Further, in this embodiment, the conductive part and the insulation part include resin matrices formed of the same resin.

### Second Embodiment

In another embodiment, for example, the metal nanowire dispersion liquid is applied selectively by a screen printing method or the like in accordance with a desired conductive pattern, and then, a resin solution for forming a conductive part is applied, to thereby form a conductive part. Meanwhile, an insulation part is formed in a region other than those in which the conductive part is formed by applying a resin solution for forming an insulation part. The resin solution for forming an insulation part preferably contains the non-conductive light-scattering body. In this embodiment, the conductive part and the insulation part may include resin matrices formed of the same resin or may include resin matrices formed of different resins.

### F. Application

The transparent conductive film may be used in electronic equipment such as a display element. More specifically, the transparent conductive film may be used as, for example, an electrode used in a touch panel or an electromagnetic wave shield for cutting off an electromagnetic wave that causes malfunctioning of electronic equipment.

### EXAMPLES

Now, the present invention is specifically described by way of Examples. However, the present invention is by no means limited to Examples described below. Evaluation methods in Examples are as described below. It should be noted that a thickness was measured with Peacock Precision Measuring Instrument Digital Gauge Cordless Type “DG-205” manufactured by Ozaki Mfg Co., Ltd.

### (1) Retardation Value

Measurement was performed with a product available under the trade name “KOBRA-WPR” from Oji Scientific Instruments. A measurement temperature was set to 23° C. and a measurement wavelength was set to 590 nm.

### (2) Surface Resistance Value

Measurement was performed with a product available under the trade name “EC-80” from Napson. A measurement temperature was set to 23° C.

### (3) Total Light Transmittance and Haze Value

Measurement was performed with a product available under the trade name “HR-100” from Murakami Color Research Laboratory Co., Ltd. at 23° C. The measurement was repeated three times and the average of the three values was defined as a measured value.

### Example 1

### Synthesis of Silver Nanowire and Preparation of Silver Nanowire Dispersion Liquid

5 Milliliters of anhydrous ethylene glycol and 0.5 ml of a solution of PtCl₂ in anhydrous ethylene glycol (concentration: 1.5×10⁻⁴ mol/L) were added to a reaction vessel equipped with a stirring device under 160° C. After a lapse of 4 minutes, 2.5 ml of a solution of AgNO₃ in anhydrous ethylene glycol (concentration: 0.12 mol/l) and 5 ml of a solution of polyvinyl pyrrolidone (MW: 5,500) in anhydrous ethylene glycol (concentration: 0.36 mol/i) were simultaneously dropped to the resultant solution over 6 minutes to produce a silver nanowire. The dropping was performed under 160° C. until AgNO₃ was completely reduced. Next, acetone was added to the reaction mixture containing the silver nanowire obtained as described above until the volume of the reaction mixture became 5 times as large as that before the addition. After that, the reaction mixture was centrifuged (2,000 rpm, 20 minutes). Thus, a silver nanowire was obtained.

The resultant silver nanowire had a short diameter of from 30 nm to 40 nm, a long diameter of from 30 nm to 50 nm, and a length of from 30 μm to 50 am.

A silver nanowire dispersion liquid was prepared by dispersing the silver nanowire (concentration: 0.2 wt %) and dodecyl-pentaethylene glycol (concentration: 0.1 wt %) in pure water.

(Preparation of Resin Solution)

A resin solution containing 100 parts by weight of butyl acetate (manufactured by Sankyo Chemical Co., Ltd.) serving as a solvent, 1.5 parts by weight of hollow nanosilica (manufactured by JGC Catalysts and Chemicals Ltd., trade name: “Thrulya 4320”, average primary particle diameter: 60 nm), and 1.5 parts by weight of a material for forming a cured layer containing an active energy ray-curable compound (manufactured by JSR Corporation, trade name: “Opstar Z7540”).

(Production of Transparent Conductive Film)

A norbornene-based cycloolefin film (manufactured by Zeon Corporation, trade name: “ZEONOR”, in-plane retardation Re=1.7 nm, thickness direction retardation Rth=1.8 nm) was used as a transparent base material.

The silver nanowire dispersion liquid was applied onto the transparent base material with a bar coater (manufactured by Dai-ichi Rika Co., Ltd., product name: “Bar Coater No. 10”), and was dried in a fan dryer at 120° C. for 2 minutes. After that, the resin solution was applied with a slot die so as to have a wet thickness of 4 μm, and was dried in a fan dryer at 120° C. for 2 minutes. Next, a transparent conductive layer including a silver nanowire in a resin matrix was formed by irradiating the resultant with UV light having an integrated illuminance of 1,400 mJ/cm² from a UV light irradiation apparatus (manufactured by Fusion UV Systems) to cure the resin.

Thus, a laminate formed of the transparent base material and the transparent conductive layer was obtained. The laminate had a surface resistance value of 153Ω/□, a total light transmittance of 91.8%, and a haze value of 1.03%.

Then, a mask having a predetermined pattern was formed on the transparent conductive layer of the laminate, and the laminate was immersed in an etchant (manufactured by Kanto Chemical Co., Inc. product name: “Mixed Acid Al Etchant”) at 40° C. for 6 minutes. After that, the mask was removed. As a result of the immersion, in a region in which the mask was not formed, the silver nanowire and hollow nanoparticles were removed, and an insulation part including air bubbles in a resin matrix was formed. Further, in a region in which the mask was formed, a conductive part including the silver nanowire in a resin matrix was formed.

Thus, a transparent conductive film having the transparent conductive layer including the conductive part and the insulation part was obtained.

The insulation part had a surface resistance value equal to or higher than the measurement upper limit (1,500Ω/□) of the device, a total light transmittance of 92.7%, and a haze value of 0.76%. The conductive part had a haze value of 1.03%, and the difference between the haze value of the conductive part and the haze value of the insulation part was 0.27%. Further, when the external appearance of the transparent conductive film was visually observed by transmitting natural light through the transparent conductive film, no conductive pattern was observed.

Further, when the transparent conductive layer of the obtained transparent conductive film was observed with an optical microscope, the silver nanowire was observed in the conductive part. Further, in the insulation part, the silver nanowire was not observed, and the air bubbles were observed. The optical microscope photographs are shown in FIG. 2.

### Comparative Example 1

A laminate (transparent conductive layer/transparent substrate) was obtained by the same method as that of Example 1 except for using, as the resin solution, a solution using, as a solvent, a mixture containing isopropyl alcohol (manufactured by Wako Pure Chemical Industries, Ltd.) and diacetone alcohol (manufactured by Wako Pure Chemical Industries, Ltd.) at a weight ratio of 1:1, the solution containing 3.0 wt % of dipentaerythritol hexaacrylate (DPHA) (manufactured by Shin-Nakamura Chemical Co., Ltd., trade name: “A-DPH”) serving as an acrylic resin and 0.09 wt % of a photoreaction initiator (manufactured by Ciba Japan, trade name: “IRGACURE 907”). The laminate had a surface resistance value of 146Ω/□, a total light transmittance of 91.2%, and a haze value of 1.02%.

Then, a mask having a predetermined pattern was formed on the transparent conductive layer of the laminate, and the laminate was immersed in an etchant (manufactured by Kanto Chemical Co., Inc. product name: “Mixed Acid Al Etchant”) at 40° C. for 6 minutes. After that, the mask was removed. As a result of the immersion, in a region in which the mask was not formed, the silver nanowire was removed, and an insulation part was formed. Further, in a region in which the mask was formed, a conductive part including the silver nanowire in a resin matrix was formed.

Thus, a transparent conductive film having the transparent conductive layer including the conductive part and the insulation part was obtained.

The insulation part had a surface resistance value equal to or higher than the measurement upper limit (1,500Ω/□) of the device, a total light transmittance of 91.7%, and a haze value of 0.61%. The conductive part had a haze value of 1.02%, and the difference between the haze value of the conductive part and the haze value of the insulation part was 0.41%. Further, when the external appearance of the transparent conductive film was visually observed by transmitting natural light through the transparent conductive film, a conductive pattern was observed.

Further, when the transparent conductive layer of the obtained transparent conductive film was observed with an optical microscope, the silver nanowire was observed in the conductive part. Further, in the insulation part, the silver nanowire was not observed. The optical microscope photographs are shown in FIG. 2.

### REFERENCE SIGNS LIST

10 transparent base material
11 transparent conductive layer
21 conductive part
22 insulation part
100 transparent conductive film

1. A transparent conductive film, comprising:
a transparent base material; and
a transparent conductive layer arranged on at least one side of the transparent base material,
wherein:
the transparent conductive layer includes a conductive part and an insulation part;
the conductive part includes a metal nanowire; and
the insulation part includes an air bubble and/or a non-conductive light-scattering body.

2. The transparent conductive film according to claim 1, wherein an absolute value of a difference between a haze value of the conductive part and a haze value of the insulation part is 0.35% or less.

3. The transparent conductive film according to claim 1, wherein the air bubble has a diameter of from 1 nm to 10,000 nm.

4. The transparent conductive film according to claim 1, wherein the metal nanowire contains one or more kinds of metals selected from the group consisting of gold, platinum, silver, and copper.

5. A touch panel, comprising the transparent conductive film of claim 1.

6. A method of producing a transparent conductive film, comprising the steps of:
applying a metal nanowire dispersion liquid onto a transparent base material, followed by applying a resin solution onto the transparent base material having applied thereonto the metal nanowire dispersion liquid, to thereby form a transparent conductive layer; and
removing the metal nanowire by a wet etching method using a mask having a predetermined pattern, to thereby form a conductive part having the predetermined pattern and an insulation part in the transparent conductive layer.

7. The method of producing a transparent conductive film according to claim 6, wherein the resin solution contains a particle that is soluble in an etchant to be used in the wet etching method.
